(19) United States
(12) Patent Application Publication
(10) Pub. No.: US 2022/0100061 A1
(43) Pub. Date: Mar. 31, 2022

(54) Securing Bracket

(71) Applicant: Components Express, Inc., Woodridge, IL (US)

(72) Inventors: John Berst, Woodridge, IL (US); Art Didyk, Chicago, IL (US); Rick Ragnini, Downers Grove, IL (US)

(73) Assignee: Components Express, Inc., Woodridge, IL (US)

(21) Appl. No.: 17/548,496

(22) Filed: Dec. 11, 2021

(51) Int. Cl. G03B 17/56; F16B 2/10; B33Y 80/00

(52) U.S. Cl. CPC G03B 17/561; B29K 2077/00; B33Y 80/00; F16B 2/10

(57) ABSTRACT

A securing bracket for holding the user-settings made using user-selections on adjustors that come with a machine vision camera is disclosed. The securing bracket mounts to the camera itself. When properly mounted, the adjustors are prevented from spinning, unscrewing, or changing settings due to vibration and thus remain in place. The securing bracket comprises a spine and a plurality of hinged arms each having a bracket pivot. The hinged arms may be stacked vertically where for example one hinged arm secures a lens-adjustor, one hinged arm secures an iris-adjustor, and one hinged arm secures a focus-adjustor.

### BACKGROUND OF THE INVENTION

FIGS. 1A-1B (Prior Art) show a conventional machine vision camera. Typical machine vision cameras can have many adjustable features, but three common adjustable machine vision features comprise lens, iris, and focus. To make adjustments, the camera bodies are typically equipped with circular adjustors that rotate about a linear axis of the camera body, and can be hand-operated to adjust either a lens, iris, or focus, among other adjustments. Within this disclosure, these will be referred to as camera-adjustors, but at times will be referred to as lens-adjustors, iris-adjustors, and focus-adjustors.

Under normal circumstances, once these adjustors are set, they can largely be expected to remain in place. However, when a machine vision camera is mounted on a robot or other environment having vibration or movement, these camera adjustors can unscrew or shake loose from the camera-body. With the higher vibrations, the threading and fastening of the adjustors just gives out. In response, some configurations use small thumbscrews to hold the adjustors in place. However, this doesn't work well, as thumbscrews are inadequate.

### THUMBSCREWS: WHY INEFFECTIVE

Within conventional machine vision camera usage, thumbscrews are often used to secure the adjustors, but this is ineffective. The embodiments herein replace thumbscrews.

Thumbscrews are often poorly machined, strip easily, or just come loose with the vibration. Self-locking thumb-screws may exist, but such items require both more space and more depth than typical thumb screws. On a typical machine vision camera body, the available surfaces for thumb screws are very thin. Not a lot of depth for accommodating threaded taps.

Some customers will replace these thumb screws with a set screw. The problem is there's not very many threads available, due to minimal depth/thickness. It's not easy to find the set screw with the proper pitch, and also the proper grade of thread. Consequently, set screws are just not very strong mechanically and are designed more for static (non-motion) environments.

Some customers presently use glue to lock these thumb screws and then screw the thumbscrews into an adjustor. If so, that adjustor may never be usable for anything else again, because the substrates are really small and the adjustors are not meant to have exposure to adhesives.

Another even more crude solution exists. Some users secured the iris and focus using electrical tape. This is a sign of how significant this problem is.

Consequently, an improved securing bracket is desired.

### BRIEF DESCRIPTION OF THE DRAWINGS

FIGS. 1A-1B (Prior Art) show a conventional machine vision camera.

FIGS. 2A, 2B, 2C, and 2D show a securing bracket for holding the user-settings made using the camera-selectors;

FIG. 3A shows the securing bracket by itself;

FIGS. 3B, 4, 5, 6, 7, and 8 show various details of the securing bracket while attached to a machine vision camera; and

FIG. 9 shows adjustors having numeric labels corresponding with actual internal diameters of a specific adjustor over which an O-ring is located.

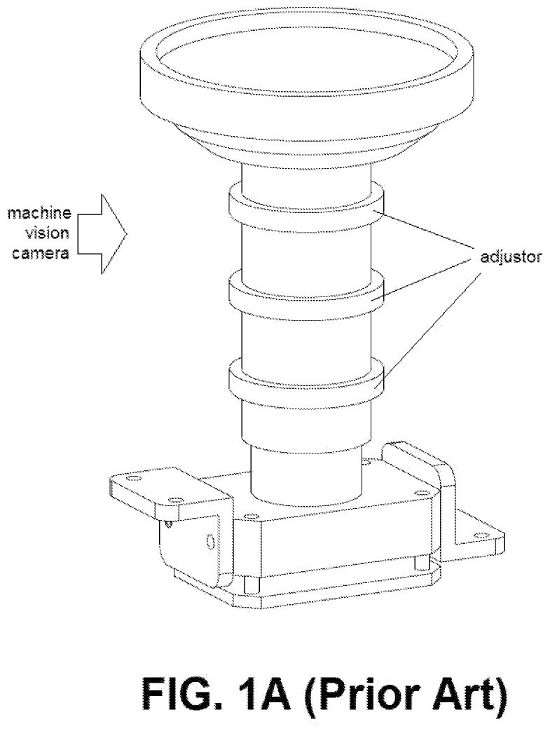

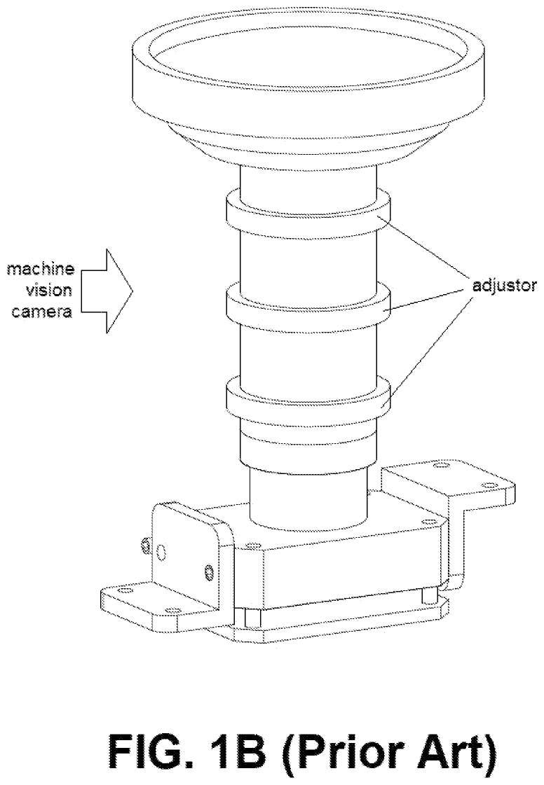

### DETAILED DESCRIPTION OF THE PREFERRED EMBODIMENTS

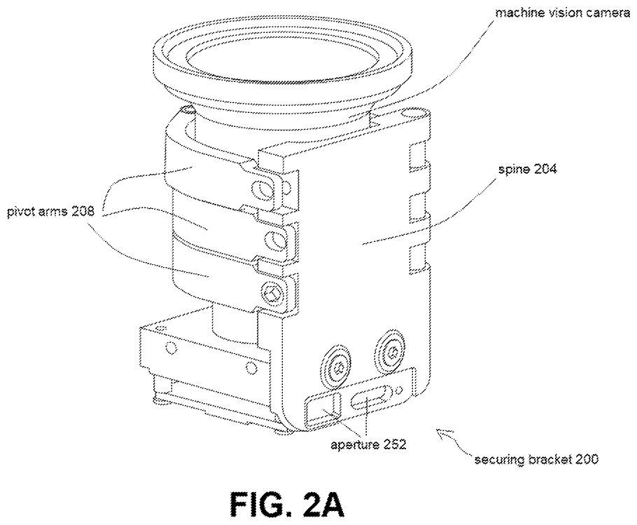

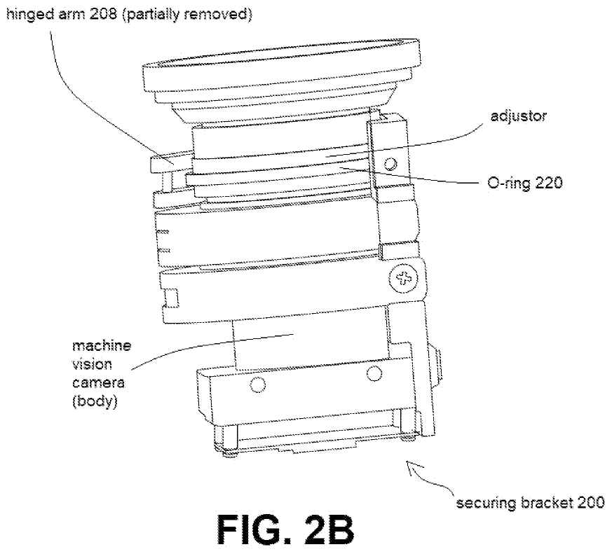

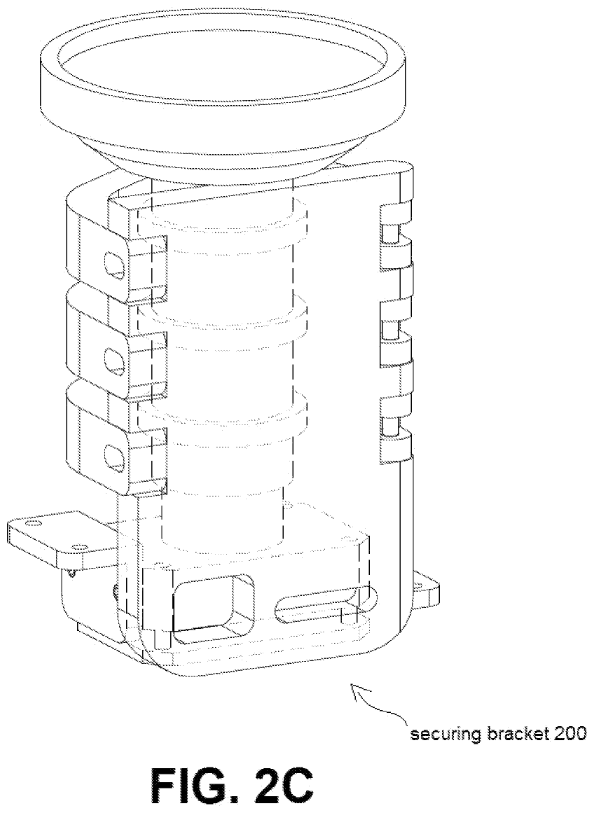

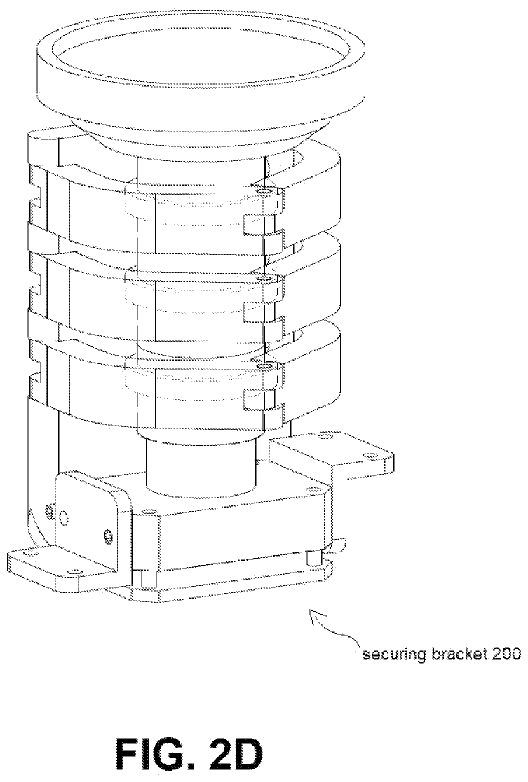

A securing bracket 200 is shown in FIGS. 2A-2D and various other Figures. The securing bracket 200 is sometimes referred to as a lens stabilization system, or lens stabilizer. The securing bracket 200 is sometimes referred to as a lens stabilization system, or lens stabilizer.

The securing bracket 200 for holding the user-settings made using the camera-selectors. The securing bracket 200 mounts to the camera itself. When properly mounted, the adjustors are prevented from spinning, unscrewing, or changing settings due to vibration and thus remain in place.

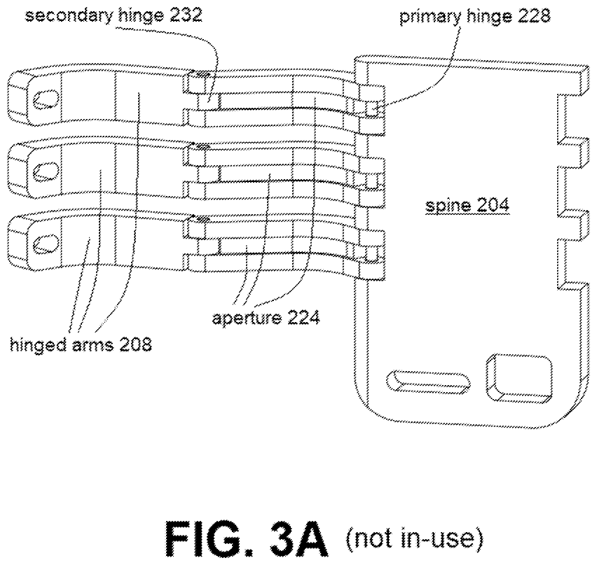

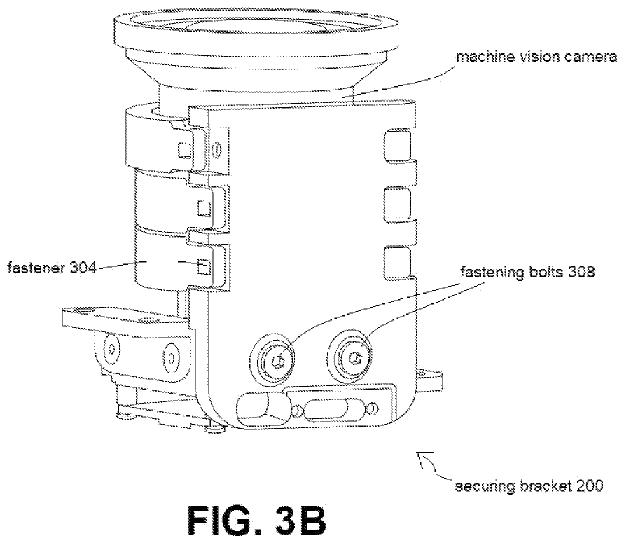

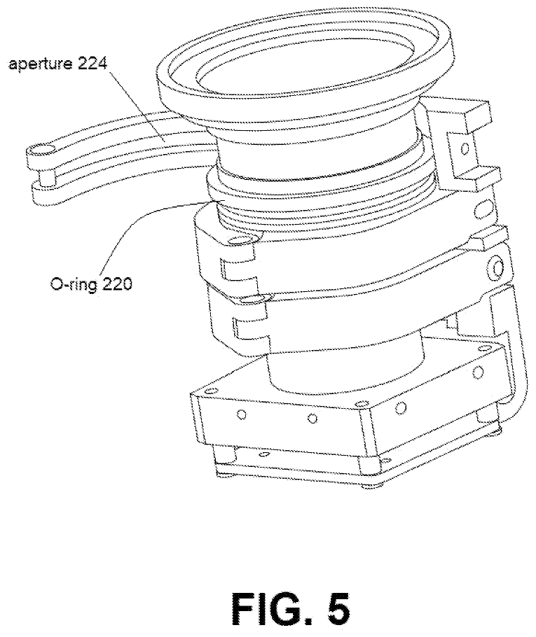

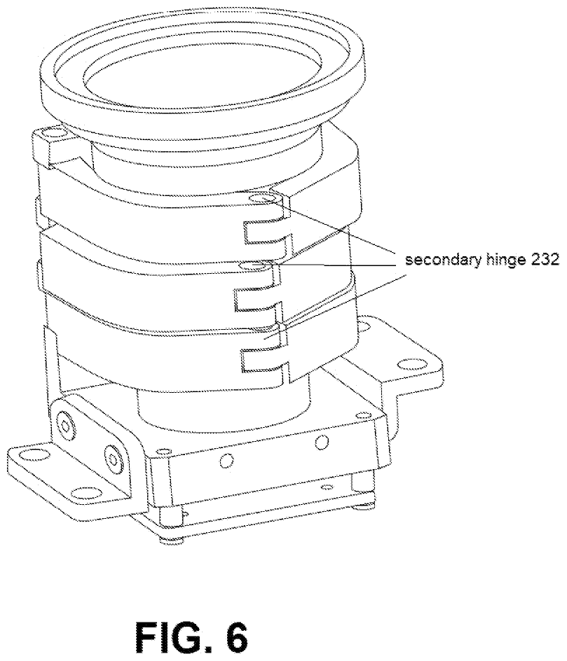

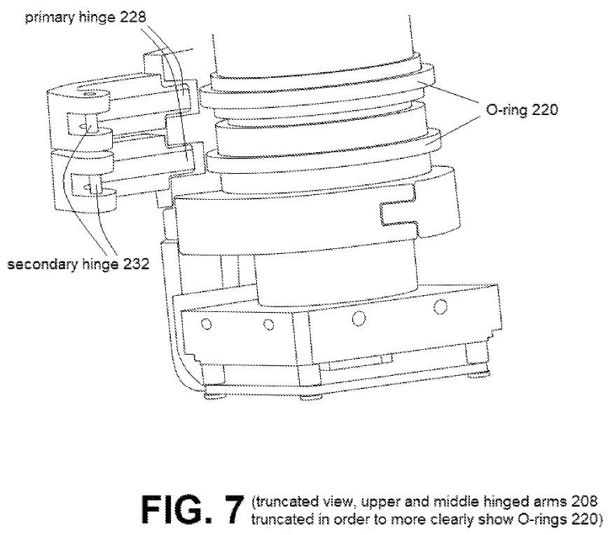

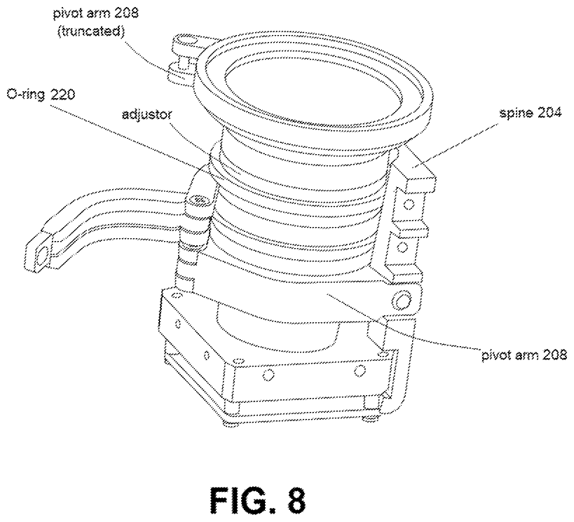

FIGS. 2A-2D show the securing bracket 200 with a machine vision camera installed therein. Meanwhile, FIG. 3A shows the securing bracket 200 by itself. FIGS. 3B and FIGS. 4-8 show various details of the securing bracket 200 while attached to a machine vision camera.

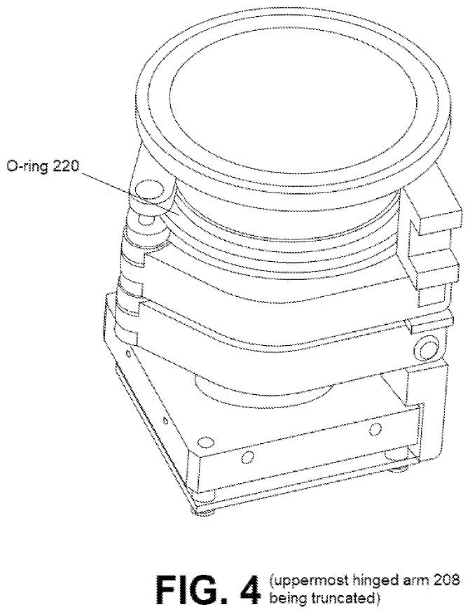

As shown in FIGS. 2A-2B, the securing bracket 200 comprises a spine 204, a plurality of hinged arms 208 each having a bracket pivot 212. For convenience and brevity, this disclosure will use examples of three hinged arms 208 stacked vertically as shown at least within FIGS. 4-9. That is, one hinged arm 208 to secure a lens-adjustor, one hinged arm 208 to secure an iris-adjustor, and one hinged arm 208 to secure a focus-adjustor.

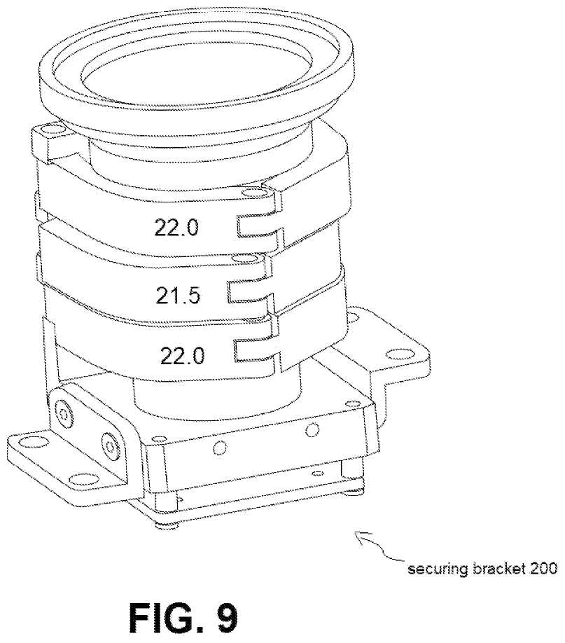

In an embodiment, the hinged arms 208 are shaped to be exactly circular when in-use. The primary embodiment of the securing bracket 200 assumes round-bodied machine vision cameras. This includes the fact that due to camera-manufacturing considerations, any specific adjustors within the same camera may have different diameters, as shown in FIG. 9.

FIGS. 2A-2B show the spine 204 having two different apertures 252 of rectangular or semi-rectangular shape. These apertures 252 provide access to connect various wires and cables to/from the camera body.

The fastening bolts (e.g. hex bolts, see FIGS. 3A-3B) keep the camera properly fastened to the securing bracket 200. FIGS. 2A-2B show the fastening bolts 308 towards the bottom of the spine 204, but that is only to mate with the camera-base and mounts attached thereto. If a specific camera required this, it's also possible to locate the fastening bolts 308 in the middle of the spine 204, and it is also possible to locate the fastening bolts 308 vertically rather than horizontally. These alterations can be made to suit specific customers and specific cameras.

### Potential Usages

A lift truck typically drives around a manufacturing floor. That lift truck may have a camera setup embedded therein. Over a period of time, a lens on the machine vision camera attached to the lift truck may start to slowly come unscrewed from the camera. Even before falling off, the camera is likely losing the focus completely. The embodiments herein ensure that that such a lens will not unscrew itself and fall off.

A military usage also exists, where a machine vision camera is attached to a howitzer. However, when the howitzer shell is fired, a considerable concussion occurs. Still, even considering such a concussion, it is still desired that a lens adjustor be kept stable. The embodiments herein address this problem.

### Potential Business Model

It is possible for entities having control over the embodiments herein to partner with an optics company, making either lenses or making other machine vision products. Potentially contract with them saying “send your 3D STL files of your lens and your camera, or send an example of it. We will make these for you. Whether 3D printing, or machining, we can do either one, it just depends on the volume of units required”.

### Composition and Use of the O-rings 220

The system 200 won't work its way loose the same way as the thumbscrews. Once installed, the hinged arms 208 are squeezing on the O-ring 220 and the O-ring 220 in turn squeezes on the adjustor resulting in 360 degrees of distributed force around the adjustor, rather than all force concentrated in a small area.

Within the embodiments herein, the adjustors on the camera body will be understood to extend all the way around the camera body, thus a full 360 degree embodiment. As such, the O-rings 220 will extend all the way around the lens.

The O-rings 220 do not grip super-tight to the adjustors. Users can adjust the securing bracket 200 while the O-rings 220 are fitted to it. In an embodiment, users will secure the hinged arms 208 into place using threaded bolts, but that is not required. One alternative could be a snap-fit.

As shown at least within FIGS. 3A, 4, and 8, the interior of the hinged arm has an aperture 224 machined or manufactured therein for accepting or accommodating the O-rings 220. One type of O-ring 220 might have a circular cross-section, another might have a rectangular cross-section, another might have the semi-round elliptical cross section. An O-ring 220 could also be star-shaped or an ‘X’ shaped cross-section. Accordingly, although not shown in FIGS. 3A, 5, and 8, the aperture 224 can also have a cross-section of any of the geometric shapes discussed herein.

Accordingly, because of the aperture 224, the main body of the securing bracket 200 never touches the lens-adjustor. It's only the O-ring 220 that actually touches the adjustor, and does so at 360 degrees in the primary embodiment.

### Variations in Geometry of the Arms 208

Some embodiments of the securing bracket 200 exist in which the adjustor is secured by less than 360 degrees of contact with the hinged arms 208. Specifically, the angles, taper, and/or curvature of these hinged arms 208 may vary, and may have different geometry depending on where a feature is located on the camera body. This is all dependent on the size of the lens or other feature. Further, in some embodiments, the label “hinged arm” may be a slight misnomer, as the arm 208 may not have the secondary hinge 232, but instead only the primary hinge 228. Such an arm 208 might be constructed in a one-piece unibody format that does not have a hinge at all, thinking of the primary hinge 228 as being part of the spine 204, not really part of the arm 208.

Even if an optical element is not round on its outside periphery, the only way to make the center part of an optical lens is to be grinded concentrically round. Thus, most machine vision lenses are round in circumference. There's no other way to make machine vision lenses optically effective. Doing so would change the path of the light and obscure the image.

Numerous drawings herein show use of a hinged arm 208 permanently attached to the spine 204 at the RH side of the spine 204 (viewed from the rear of the spine 204, e.g. FIGS. 2C, 3B). These same drawings also show the hinged arm 208 fastened on the left with a screw or being snap-fit. However, the embodiments herein could also have a hinged arm 208 that is curved, no hinge, and has just a simple round shape. This embodiment could also have the hinged arm 208 (so named but at times a mis-nomer) having an elliptical geometry.

Next, various Figures show one finger that extends all the way from the right around the camera, body, and then connect on the left. However, an alternate embodiment utilizes two arms 208 where they meet in the middle and either snap together, are bolted together, or are fastened in some other way. However, many other fastening mechanisms could also be used.

The hinged arms 208 are shown as very much round, but could also be round-ish or angled in a way that would lend itself better to molding/manufacturing, but still provide an effective gripping force onto the O-rings 200 and thus the camera enclosed therein.

FIG. 9 shows adjustors having numeric labels 22.0, 21.5, and then 22.0. Those are actual internal diameters of a specific adjustor over which an O-ring 220 is located. For some reason or another, one camera feature may have a different diameter. Camera manufacturers make some of their features a little bit smaller for e.g. a lens-adjustor than for an iris-adjustor or a focus-adjustor. The system 200 can accommodate such differing geometries by, for example, equipping a specific configuration with hinged arms 208 that are unequal in size.

### Variations in the Securing Bracket 200

In a typical machine vision camera, the iris, focus, and lens must all be held securely in place. However, some customers may not care about the iris. They may only care about the focus or the lens, so that they would only want a two arm embodiment, rather than the three arm embodiment shown in most of the Figures. Next, within some machine vision cameras, users can not adjust the focus or can not adjust the iris. For whatever reason, these may be fixed. As such, the securing bracket 200 could have just two hinged arms 208, or could be just a single arm. The remaining hinged arms 208 could still attach, but attach to nothing. Or, the hinged arms 208 could be omitted, or detachable.

### Why Existing Solutions are Inadequate

People make lenses for ruggedized applications where they set the lens and then it gets internally glued. The problem is when searching for those lenses, that lens may not exist. Someone may need a 12 megapixel with a specific field of view and other requirements, plus ruggedized. That lens may not exist. It's possible that no one makes that ruggedized lens, e.g. in a military context. The embodiments herein effectively address that problem.

Even supposing a proper lens exists, ruggedization has its merits, but does not address the issue of a camera gradually losing its settings and adjustor-positions over time, due to repeated vibrations and shocks. Another problem is that such ruggedized lenses are expensive. Consequently, the embodiments herein provide a more economical way of handling this kind of a problem.

Another issue is cost. Some machine vision cameras are customized with specialized lenses. In the case of the lift truck application, one lens might cost at least $500 or $600. For a 12 megapixel lens, it's very common for these lenses to cost several thousand dollars. The lens might be more expensive than the actual camera in which that lens is located. Now also consider putting a camera on the arm of the robot. A similar problem will exist because robots got thousands of stops and starts. On a typical robot arm, acceleration, torque, and shaking can be very high.

Manufacturing \Assembly

A manufacturer could 3D print the spine 204 first and then print the hinged arms 208, or could also 3D print these at the same time. Then, position the hinged arms 208 near to the hinge-fixture within the spine 204 and then insert a bolt to match with threads in the primary hinge 228. The bolt could have Phillips head.

Potential filaments for the 3D printers could be plastic, or can be made out of aluminum or hybrid if necessary, this depends on the specific environment. Might have one material, but if there's a messy, dirty, dusty environment that requires more washing, which would be a different filament and resulting material. The choice of filament will be made on the criteria of striving for rigid or semi-rigid with a little bit of flexibility, in case one costs less or is easier to manufacture.

If someone wanted to do a big production run, e.g. a thousand, 10,000 they could use injection molding to make the securing brackets 200. Could be casting machine. Meanwhile, a typical 3D print takes over 16 hours for just one single unit, and then couple of hours of cleanup.

### Disclaimer

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method of manufacturing a securing bracket for use on a manually adjustable machine vision cameras, comprising:
configuring a rectangular spine to have a plurality of symmetrical hinged arms;
positioning the plurality of hinged arms transverse to a vertical axis of the rectangular spine and each of the plurality of hinged arms joined in pairs to the spine; and
configuring each of the plurality of hinged arms having a bracket pivot.

2. The method of claim 1, further comprising:
manufacturing the plurality of hinged arms to have a horizontal interior aperture; and
configuring the interior aperture of the hinged arms to mate with and have a size corresponding with an O-ring previously attached to a camera-adjustor on a body of the camera.

3. The method of claim 2, further comprising:
the plurality of hinged arms attaching to the O-rings all the way around the camera body.

4. The method of claim 1, further comprising:
configuring one or more of the hinged arms to be omitted or detachable.

5. The method of claim 3, further comprising:
configuring a first hinged arm to correspond with a lens-adjustor within the camera;
configuring a second hinged arm to correspond with an iris-adjustor within the camera; and
configuring a third hinged arm to correspond with a focus-adjustor within the camera.

6. The method of claim 3, further comprising:
determining a desired volume of securing brackets to be manufactured;
if the desired volume is below a predetermined threshold, 3D printing the securing brackets from a structural nylon filament; and
if the desired volume is above a predetermined threshold, machining and then assembling the securing brackets.

7. The method of claim 3, further comprising:
configuring the securing bracket to fit around a camera mounted within a lift truck.

8. The method of claim 3, further comprising:
configuring the securing bracket to fit around camera mounted within a military howitzer.

9. The method of claim 3, further comprising:
custom-manufacturing one or more securing brackets according to customer-supplied stereolithography (STL) files of customer camera.

10. The method of claim 3, further comprising:
during use, one or more pairs of hinged arms compressing the O-ring and the O-ring in turn compressing an adjustor, thereby
providing lens a 360 degree force around the camera body.

11. The method of claim 10, further comprising:
any pair of hinged arms precluded from touching an adjustor;
only the O-ring touching any camera-adjustor.

12. The method of claim 11, further comprising:
providing compression force all the way around the camera-adjustor.

13. The method of claim 11, further comprising:
providing compression at less than all the way around the camera-adjustor.

14. The method of claim 5, further comprising:
in response to the size and roundness of one or more of the camera-adjustors differing from one or more of the other of the camera-adjustors, configuring an angle and roundness of one or more of the pairs of hinged arms differ from one or more of the other of the pairs of hinged arms, according to a variance in the size of the specific camera adjustor.

15. The method of claim 3, further comprising:
configuring the securing bracket to work with one or more camera-adjustors on a camera body that is cylindrical.

16. The method of claim 3, further comprising:
configuring the securing bracket to work with one or more camera-adjustors on a camera body that is non-cylindrical.

17. The method of claim 15, further comprising:
applying the securing bracket to camera-adjustors having differing widths.

18. The method of claim 15, further comprising:
applying the securing bracket to camera-adjustors having differing thresholds for coming loose.
